(19) United States
(12) Patent Application Publication
(10) Pub. No.: US 2011/0258656 A1
(43) Pub. Date: Oct. 20, 2011

(54) System and method for television application channel sync (TACS)

(75) Inventor: Kenneth Michel, Brightwaters, NY (US)

(73) Assignee: DISNEY ENTERPRISES, INC., BURBANK, CA (US)

(21) Appl. No.: 12/799,151

(22) Filed: Apr. 19, 2010

(51) Int. Cl. H04N 7/16; H04N 5/445

(52) U.S. Cl. 725/27; 725/56

(57) ABSTRACT

There is provided a system and method for providing television application channel sync (TACS). There is provided a method comprising determining a channel presently tuned from a plurality of tunable channels, applying a plurality of business rules to the channel to present, on a display, a list of selectable television applications from a plurality of television applications requiring access to a network, associating the channel to a selection of television applications from the list, and rendering the selection of television applications concurrently with the channel on the display while the channel is presently tuned. The business rules may be flexibly configured to prevent television applications from displaying unsuitable, unrelated or irrelevant content with channel video content, thus providing a unified and coherent presentation for viewers while preserving the intended messages of primary programming content providers and advertising partners.

### BACKGROUND OF THE INVENTION

1. Field of the Invention

The present invention relates generally to video broadcast. More particularly, the present invention relates to applications for video broadcast.

2. Background Art

Conventional television broadcast, streaming video, video on demand and other video programming services are popular and widely used. However, users are increasingly demanding a more interactive experience from their viewing experiences. As such, many users are becoming accustomed to concurrently accessing the Internet on a separate device, such as a laptop or mobile phone, to supplement conventional video program viewing with participation in online communities providing chat, forums, polls, social networking, and other features. Unfortunately, such multitasking is cumbersome and distracting, preventing users from fully enjoying the primary video programming.

In response, a new generation of Internet enabled video set-top boxes, high definition televisions, and portable media consumption devices such as tablets and mobile phones are providing highly interactive watching experiences to users. In particular, some devices are now offering Internet based widgets or applications (“apps”) that are overlaid or displayed side-by-side with the provided video content, allowing users to remain focused on a single screen to fully enjoy the viewing experience. However, there is the risk that these widgets or apps may include content that is distracting, irrelevant, or contrary to the primary video content being shown. As a result, users are confused by different messages competing for their attention, program content providers and networks suffer damage to their image and brand, and advertising partners cannot market their messages effectively.

Accordingly, there is a need to overcome the drawbacks and deficiencies in the art by providing a way to augment media streaming with network based applications while minimizing the risk of presenting distracting, competing, or conflicting contents.

### SUMMARY OF THE INVENTION

There are provided systems and methods for providing television application channel sync (TACS), substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for providing TACS, according to one embodiment of the present invention;

FIG. 2 presents an interface for TACS, according to one embodiment of the present invention;

FIG. 3 presents a table of business rules for implementing TACS, according to one embodiment of the present invention; and

FIG. 4 shows a flowchart describing the steps, according to one embodiment of the present invention, by which TACS may be provided.

### DETAILED DESCRIPTION OF THE INVENTION

The present application is directed to a system and method for providing personalized dynamic web content based on photographic data, such as television application channel sync (TACS). The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

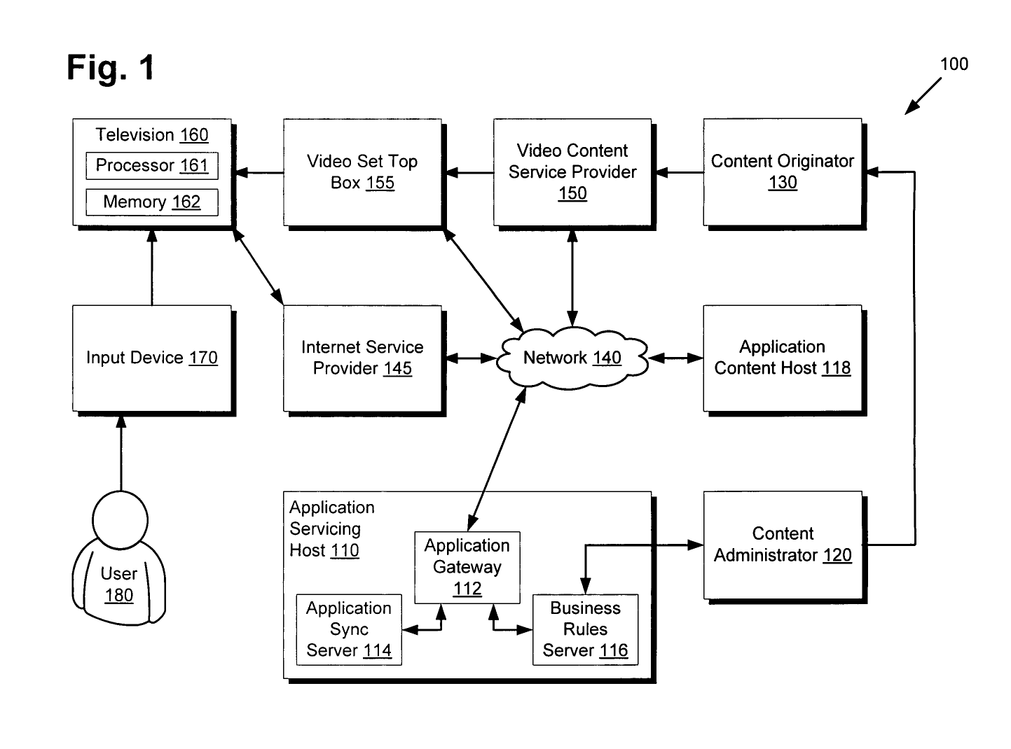

FIG. 1 presents a diagram of a system for providing TACS, according to one embodiment of the present invention. Diagram 100 of FIG. 1 includes application servicing host 110, application content host 118, content administrator 120, content originator 130, network 140, Internet service provider 145, video content service provider 150, video set top box 155, television 160, input device 170, and user 180. Application servicing host 110 includes application gateway 112, application sync server 114, and business rules server 116. Television 160 includes processor 161 and memory 162.

Television 160 may comprise an Internet Protocol (IP) enabled high definition television (HDTV). More generally, television 160 may comprise any device capable of receiving and displaying video content and television applications or widgets (“apps”) using processor 161, such as a mobile phone, a tablet computer, a portable media player, a video game console connected to a display, a portable gaming system, or another device.

As shown in diagram 100, video set top box 155 may receive video content originating from content originator 130, which may for example comprise a television network or local program provider, via video content service provider 150, which may comprise for example a multi-channel video programming distributor (MVPD), using satellite, cable, fiber optics, wireless broadcast, or other transmission methods. Video content service provider 150 may also provide IP service to network 140, which may comprise the Internet. Video set top box 155 may also be configured to directly access network 140. Television 160 may access network 160 via Internet service provider (ISP) 145, which may provide Internet access via DSL, cable, fiber optics, wireless broadcast, or other transmission methods. For example, a connection to ISP 145 may be shared locally by a wireless or wired router, allowing television 160 to access ISP 145 using, for example, a Wi-Fi or Ethernet connection.

Besides video content, television 160 may also execute and display apps retrieved from application servicing host 110 via network 140. Application servicing host 110 may be affiliated with a manufacturer or vendor of television 160 or video set top box 155, but alternative third party contractual hosting arrangements may also be used as well. Application gateway 112 may provide external access to apps stored in application sync server 114. Application gateway 112 may also retrieve relevant business rules for such apps from business rules server 116. As shown in FIG. 1, content administrator 120 may have access to business rules server 116 to set and modify business rules relating to content provided by content originator 130 with respect to apps provided by application sync server 114. The apps may rely on outside servers such as application content host 118 for external content. Application content host 118 may host various assets that apps can access, modify, or contribute to, such as images, video, databases, and other content.

User 180 may then use input device 170, which may comprise, for example, a remote control, a keyboard and mouse, a touchscreen panel, a game controller, or another user input device to browse for a desired channel from video set top box 155 and desired apps from application sync server 114. Apps may then be “synced” to particular channels, such that only approved or available apps automatically display on television 160 when a corresponding channel is selected for viewing. From this subset of approved apps, the user may select the desired apps to display for that particular channel. This sync information may be stored, for example, in memory 162, after being retrieved from application servicing host 110. Memory 162 may comprise, for example, a non-volatile memory such as flash memory that can retain data between power cycling. In this manner, the user can perform TACS by “tacking” or sticking apps to particular channels, where the apps are selected from an approved subset of apps.

Diagram 100 of FIG. 1 is shown in a simplified manner for reasons of clarity. In alternative embodiments, video content service provider 150 may provide service to a plurality of video set top boxes and users, multiple channels may be supported by several content administrators and content originators, several application content hosts may provide asset servicing for apps, and several application servicing hosts may be provided for load balancing or to support different television and video content service vendors and manufacturers.

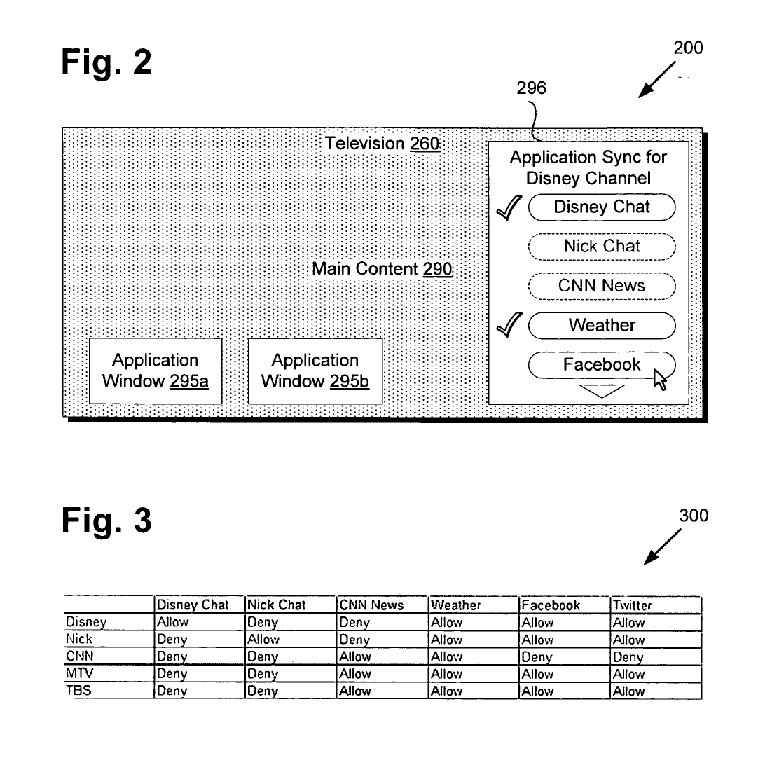

Moving to FIG. 2, FIG. 2 presents an interface for TACS, according to one embodiment of the present invention. Diagram 200 of FIG. 2 includes television 260 displaying a user interface, including main content 290, application windows 295a and 295b, and sync window 296. Television 260 corresponds to television 160 in FIG. 1. The interface shown on the display of television 260 may, for example, be correspondingly rendered by processor 161 in FIG. 1, or by video set top box 155 in FIG. 1.

Main content 290 may comprise the main video content of a selected channel. In the example shown in FIG. 2, main content 290 may display the Disney channel. As shown in sync window 296, a plurality of apps are shown to the user, with the apps “Disney Chat” and “Weather” enabled as indicated by the check marks. Application window 295a may therefore show a window comprising the “Disney Chat” app, and application window 295b may show a window comprising the “Weather” app. The “Disney Chat” app may, for example, provide a moderated chat room for Disney related topics, and the “Weather” app may, for example, provide current local weather conditions. While application windows 295a and 295b are shown as overlays at the bottom-left of the display, alternative embodiments may position application windows in different positions or side-by-side with main content 290, and such positioning may be user configurable. The app selections in sync window 296 may be remembered on a per-channel basis to provide television app channel sync, where user selected apps are synced to channels in a manner that does not interfere with the main channel content.

As shown in sync window 296, the “Nick Chat” and “CNN News” apps are grayed out and disabled for selection. The “Nick Chat” app may, for example, provide a moderated chat room for Nick related programs, and the “CNN News” app may, for example, provide a news ticker with news stories from CNN. Since the content of the “Nick Chat” and “CNN News” apps may be unsuitable, unrelated and irrelevant when main content 290 is showing the Disney channel, they are disabled for selection to preserve the focus of available screen real estate on main content 290. By enforcing on-screen content coherency in the above manner, networks can ensure that their content is being delivered in an optimal manner and that competitors cannot free ride on their content and advertising dollars. Thus, the risk of users selecting apps with conflicting or competing content is reduced, allowing main content 290 to remain the primary focus for viewers.

Moving to FIG. 3, FIG. 3 presents a table of business rules for implementing TACS, according to one embodiment of the present invention. Table 300 may be contained within a database stored in business rules server 116 of FIG. 1. As shown in table 300, rows indicate channels or television networks while columns indicate apps. Table cells indicate whether the app is allowed or denied for the associated channel. The owners or administrators for each channel or television network may configure these business rules, as shown by content administrator 120 interfacing with business rules server 116 in FIG. 1. The table in FIG. 3 is simplified for clarity, as alternative embodiments may include multiple tables to support several different video content service providers or vendors, and may include more complex rules to support, for example, program level rules or time based rules to supplement or replace channel level rules. For example, rule permissions may change depending on certain defined time periods or based on a particular program being shown.

Thus, it can be seen that sync window 296 is using the information provided by table 300 to present a restricted list of available apps to the user for selection. Since “Nick Chat” and “CNN News” are set as “Deny” for the “Disney” channel, these selections are shown as grayed out and disabled in sync window 296. Alternative embodiments may use other presentation methods to indicate disabled selections, such as reordering apps flagged as “Deny” towards the bottom of sync window 296, or removing them completely from view in sync window 296.

The remaining examples in table 300 may help further illustrate business rules that are configured to preserve the value of channel programming by denying the selection of possibly distracting apps. As seen in the Nick channel row, the “Disney Chat” app is now set to Deny whereas the “Nick Chat” app is now set to Allow. In this manner, chat apps are kept topical to each respective channel, as displaying unrelated or competitor chat contents may be detrimental for the viewing experience. The “CNN” network is shown as denying both chat apps, as they may be considered largely unrelated to current event news. Further, the “CNN” network is set to deny the “Facebook” and “Twitter” apps, as such social networking apps may be considered unsuitable, unrelated or irrelevant for a news program. Thus, each network may set and configure their own preferred permissions for third party television widgets or apps, thereby preserving the value of their programming content.

Furthermore, granting “Allow” permission to apps may be contingent on separate negotiated contracts, allowing more refined control over the display of app content. For example, it can be seen in the Disney channel row that both Facebook and Twitter are set to “Allow.” This arrangement may, for example, be contingent on an agreement that the Facebook and Twitter apps are not allowed to show any advertising content, which may conflict with advertising content shown in main content 290 or dilute the value of programming shown in main content 290. Or, for example, such arrangement may be contingent on the addition of language and content filters or human moderation to restrict subject matter for particular audiences. These contingencies may, for example, be stored as explicit rules within business rules server 116, or may be separately agreed to and enforced. Thus, even if apps are set to “Allow”, the content of such apps may be further restricted according to various business rules that are stored in business rules server 116 or externally enforced. Thus, depending on the preferences of each channel content owner or administrator, fine-tuned contractual agreements may be negotiated with app developers, or simple all-or-nothing controls may be adopted. Application servicing host 110 may provide further criteria for restriction rules, as previously discussed, such as time-based or program-based restrictions. In this manner, channel network administrators can configure business rules as specifically or generally as desired.

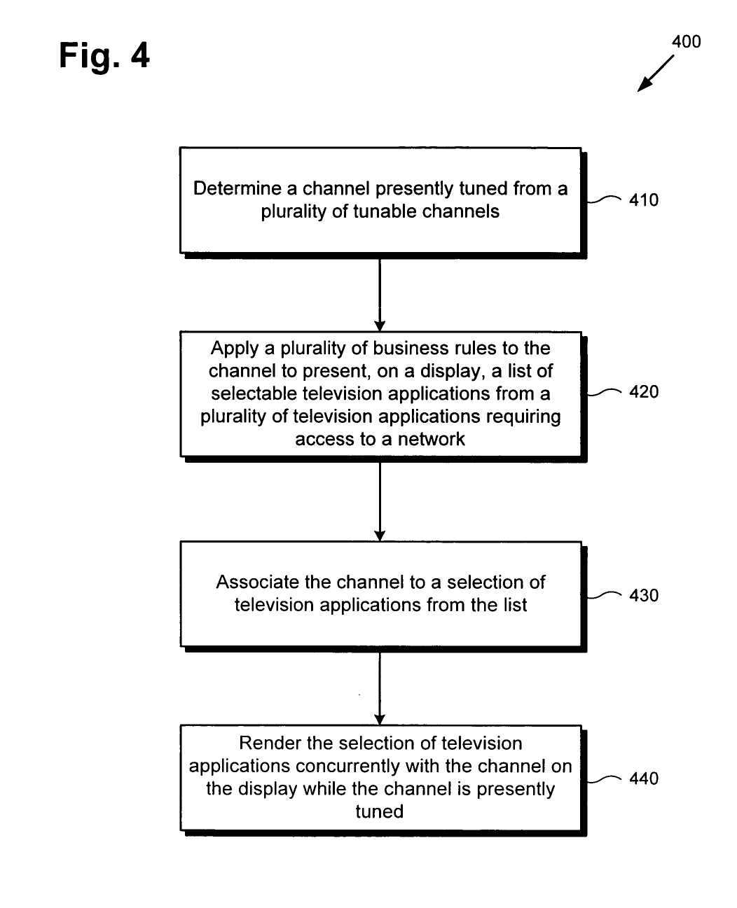

FIG. 4 shows a flowchart describing the steps, according to one embodiment of the present invention, by which TACS may be provided. Certain details and features have been left out of flowchart 400 that are apparent to a person of ordinary skill in the art. For example, a step may comprise one or more substeps or may involve specialized equipment or materials, as known in the art. While steps 410 through 440 indicated in flowchart 400 are sufficient to describe one embodiment of the present invention, other embodiments of the invention may utilize steps different from those shown in flowchart 400.

Referring to step 410 of flowchart 400 in FIG. 4 and diagram 100 of FIG. 1, step 410 of flowchart 400 comprises processor 161 of television 160 determining a channel presently tuned from a plurality of tunable channels. More specifically, television 160 may determine that video set top box 155 is tuned to content originator 130 via video content service provider 150, which may receive content as a MVPD from several television networks providing the plurality of tunable channels. For example, content originator 130 may provide video content for the Disney channel. Thus, processor 161 may recognize that television 160 is currently tuned to the Disney channel.

Referring to step 420 of flowchart 400 in FIG. 4 and diagram 100 of FIG. 1, step 420 of flowchart 400 comprises processor 161 of television 160 applying a plurality of business rules to the channel determined from step 410 to present, on a display of television 160, a list of selectable television applications from a plurality of television applications requiring access to network 140. As previously discussed, the plurality of business rules may be stored within business rules server 116 of application servicing host 110. The plurality of television applications or apps may be stored in application sync server 114. The apps require may require access to network 140 to retrieve or modify online assets stored in, for example, application content host 118. Application gateway 112 may provide access to the business rules and apps through, for example, a web interface exposed over network 140. Additionally, as shown in FIG. 1, content administrator 120 may have access to modify rules stored in business rules server 116 pertaining to content under its control.

Once processor 161 retrieves the business rules and television apps via application gateway 112 of application servicing host 110, the business rules are then applied to the specific channel determined in step 410 to create the list of selectable television applications. Continuing with the Disney channel example, as shown by table 300 in FIG. 3 representing a plurality of business rules, the list of selectable television applications would then comprise a list including the “Disney Chat”, “Weather”, “Facebook”, and “Twitter” television applications. As previously discussed, besides channel based permissions, the business rules may be flexibly configured to provide more specific permissions and access controls based on time, programming, or contractual agreements between content providers and application developers. Once the list is created, it may then be displayed on television 160, for example as sync window 296 in FIG. 2.

Referring to step 430 of flowchart 400 in FIG. 4 and diagram 100 of FIG. 1, step 430 of flowchart 400 comprises processor 161 of television 160 associating the channel determined in step 410 to a selection of television applications from the list displayed in step 420. For example, user 180 may use input device 170 to select desired television applications from the list presented in step 420. As shown in sync window 296 of FIG. 2, the user may have selected the “Disney Chat” and the “Weather” television applications to be associated or synced with the “Disney” channel. This association may then be recorded, for example, as data in memory 162.

Referring to step 440 of flowchart 400 in FIG. 4 and diagram 100 of FIG. 1, step 440 of flowchart 400 comprises processor 161 of television 160 rendering the selection of television applications associated in step 430 concurrently with the channel determined in step 410 on the display of television 160 while the channel is presently tuned. For example, as shown by the display of television 260 in FIG. 2, application windows 295a and 295b corresponding to the television applications associated in step 430, or “Disney Chat” and “Weather”, are shown overlaid on top of main content 290 comprising video content for the “Disney” channel. If this channel sync is recorded in a non-volatile memory, such as memory 162, then television 260 may show the synced television applications “Disney Chat” and “Weather” in application windows 295a-295b whenever the “Disney” channel is tuned and shown in main content 290, even if television 260 is power cycled or turned off and on. As previously discussed, while application windows 295a and 295b are shown as overlays in the bottom-left corner, alternative positioning arrangements such as a side-by-side view may also be supported so long as both the application windows and the main content are viewable concurrently on the same display.

Content administrators and owners may thus flexibly configure business rules at business rules server 116 to balance application accessibility with a coherent and unified presentation of diverse content. By implementing TACS as described above in steps 410 through 440, the contents of application windows 295a and 295b are thereby restricted from presenting conflicting or competing content that is unsuitable, unrelated or irrelevant for main content 290. Thus, users can enjoy a more focused and enjoyable viewing experience augmented by their favorite network enabled applications or widgets. At the same time, content owners and primary programming providers can preserve the intended message and value of their broadcasts by effectively managing app content appearing on valuable screen real estate, enabling advertising partners to effectively market their messages without dilution from free riding or competing content sources.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method of providing television application channel sync, the method comprising:
determining a channel presently tuned from a plurality of tunable channels;
applying a plurality of business rules to the channel to present, on a display, a list of selectable television applications from a plurality of television applications requiring access to a network;
associating the channel to a selection of television applications from the list; and
rendering the selection of television applications concurrently with the channel on the display while the channel is presently tuned.

2. The method of claim 1, wherein the plurality of business rules include access permissions specifying whether each of the plurality of television applications is allowed or denied for each of the plurality of tunable channels.

3. The method of claim 1, wherein the plurality of business rules include access permissions for each of the plurality of television applications in relation to defined time periods.

4. The method of claim 1, wherein the plurality of business rules include access permissions for each of the plurality of television applications in relation to specific programs.

5. The method of claim 1, wherein the plurality of business rules include access permissions based on contractual agreements between content owners of the plurality of tunable channels and application developers of the plurality of television applications.

6. The method of claim 1, wherein the network comprises the Internet.

7. The method of claim 1, wherein presenting the list of selectable television applications shows non-selectable television applications as grayed out on the display.

8. The method of claim 1 further comprising, prior to the associating of the selection of television applications to the channel, receiving the selection of television applications from an input device.

9. The method of claim 1 further comprising, after the associating of the selection of television applications to the channel, storing the associating as data in a non-volatile memory.

10. The method of claim 1 further comprising, prior to applying the plurality of business rules, retrieving the plurality of business rules and the plurality of television applications from an application servicing host over the network.

11. A media streaming device providing television application channel sync, the device comprising:
a processor configured to:
determine a channel presently tuned from a plurality of tunable channels;
apply a plurality of business rules to the channel to present, on a display, a list of selectable television applications from a plurality of television applications requiring access to a network;
associate the channel to a selection of television applications from the list; and
render the selection of television applications concurrently with the channel on the display while the channel is presently tuned.

12. The device of claim 11, wherein the plurality of business rules include access permissions specifying whether each of the plurality of television applications is allowed or denied for each of the plurality of tunable channels.

13. The device of claim 11, wherein the plurality of business rules include access permissions for each of the plurality of television applications in relation to defined time periods.

14. The device of claim 11, wherein the plurality of business rules include access permissions for each of the plurality of television applications in relation to specific programs.

15. The device of claim 11, wherein the plurality of business rules include access permissions based on contractual agreements between content owners of the plurality of tunable channels and application developers of the plurality of television applications.

16. The device of claim 11, wherein the network comprises the Internet.

17. The device of claim 11, wherein the processor is further configured to present the list of selectable television applications by showing non-selectable television applications as grayed out on the display.

18. The device of claim 11 wherein prior to the associating of the selection of television applications to the channel the processor is further configured to receive the selection of television applications from an input device.

19. The device of claim 11 wherein after the associating of the selection of television applications to the channel the processor is further configured to store the associating as data in a non-volatile memory.

20. The device of claim 11 wherein prior to applying the plurality of business rules the processor is further configured to retrieve the plurality of business rules and the plurality of television applications from an application servicing host over the network.
